(19) United States
(12) Patent Application Publication
(10) Pub. No.: US 2014/0057647 A1
(43) Pub. Date: Feb. 27, 2014

(54) MOBILE TERMINAL, CLOUD SERVER, AND METHOD FOR IDENTIFYING HOT SPOT

(71) Applicant: HON HAI PRECISION INDUSTRY CO., LTD., New Taipei (TW)

(72) Inventor: Chun-Chieh CHANG, New Taipei (TW)

(73) Assignee: HON HAI PRECISION INDUSTRY CO., LTD., New Taipei (TW)

(21) Appl. No.: 13/726,664

(22) Filed: Dec. 26, 2012

(30) Foreign Application Priority Data
Aug. 21, 2012 (TW) 101130325

(51) Int. Cl. H04W 64/00

(52) U.S. Cl. CPC H04W 64/003; H04L 67/42
USPC 455/456.1; 709/203

(57) ABSTRACT

A method for identifying hot spots by providing an electronic map and receiving terminal data from plurality of mobile terminals. The terminal data comprising position information of the corresponding mobile terminal, time information when the terminal date from the corresponding mobile terminal is received. The method further determining positions on the electronic map to be hot spots based on the number of the terminal data received from the same position in a predetermined time period according to the terminal data.

### BACKGROUND

1. Technical Field

The present disclosure relates to communication technology, and particularly to a mobile terminal, a cloud server and a method for identifying hot spot.

2. Description of Related Art

Most people take pictures of interesting places, such as scenic spots, volcanic regions, accidents, and of natural disasters. These places are called hot spots. However, some spontaneous occurring hotspots, if they are disaster related, may need to be shared with the public, but some spontaneous occurring incidents cannot be known in advance.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of the functioning modules of a communication system; the communication system includes a plurality of mobile terminals and a cloud server.

FIG. 2 is a block diagram of the functioning modules of the mobile terminal in FIG. 1.

FIG. 3 is a block diagram of the functioning modules of a cloud server in FIG. 1.

FIG. 4 is sketch map of a graphical user interface provided by the cloud server in FIG. 3.

FIG. 5 is a flow chart of a method for identifying hot spots.

FIGS. 6-8 are flow charts of sub-methods for identifying hot spots.

### DETAILED DESCRIPTION

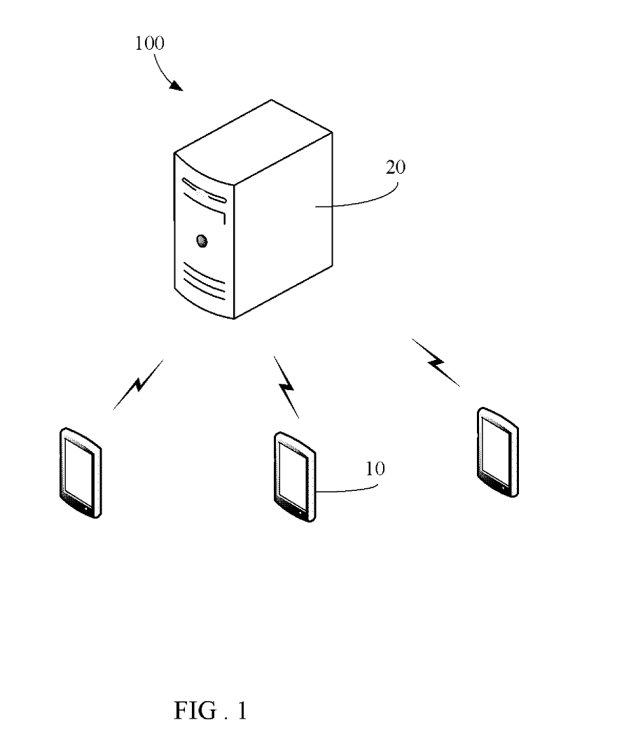

FIG. 1 shows a communication system 100 of one embodiment. The communication system 100 includes a plurality of mobile terminals 10, and a cloud server 20 communicating with the mobile terminals 10 via a network. The mobile terminals 10 may be a mobile phone, a personal digital assistant (PDA), or a tablet computer. The network may be a 3G network, a GPRS network, or the Internet network. Each mobile terminal 10 has an exclusive identifier, such as a subscriber identity module (SIM) card, a model number.

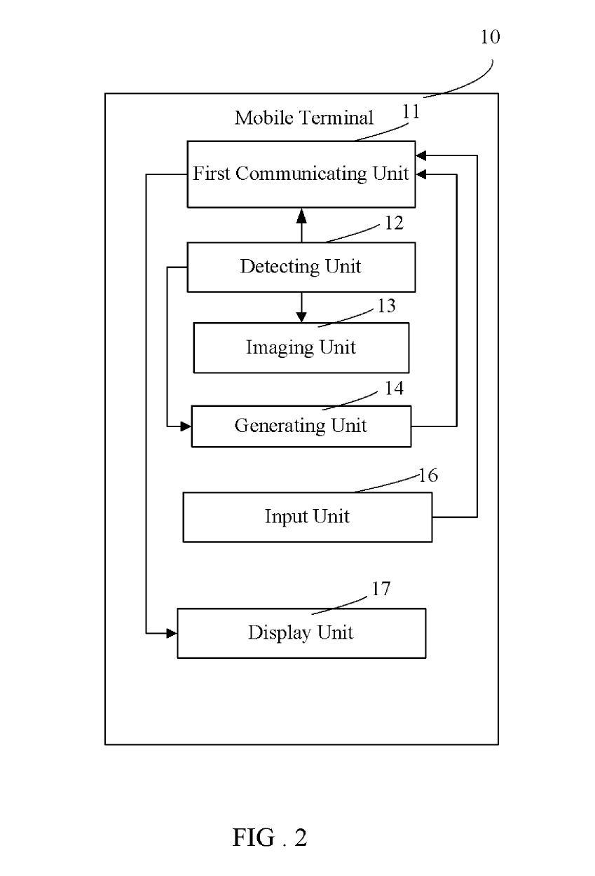

FIG. 2 shows that the mobile terminal 10 includes a first communicating unit 11, a detecting unit 12, an imaging unit 13, a generating unit 14, an input unit 16, and a display unit 17.

The first communicating unit 11 is configured to connect to the cloud server 20, and communicate with the cloud server 20.

The imaging unit 13 is configured to take images and generate a detecting signal when the images are taken. The image may be a static image or a dynamic image.

The detecting unit 12 is configured to detect whether the first communicating unit 11 is connected to the cloud server 20 in response to the detecting signal. The detecting unit 12 is further configured to generate an obtaining signal when the first communicating unit 11 is detected to be connected to the cloud server 20.

The generating unit 14 is configured to generate terminal data containing position information, time information, and the identifier of the mobile terminal 10. For example, the generating unit 14 includes a GPS unit for obtaining current time information and current position information of the mobile terminal 10. The time information is universal time coordinated (UTC). The terminal data is transmitted to the cloud server 20, such that the cloud server 20 is capable of identifying hot spots based on the terminal data. How the cloud server 20 identifiers the hot spots will be described below.

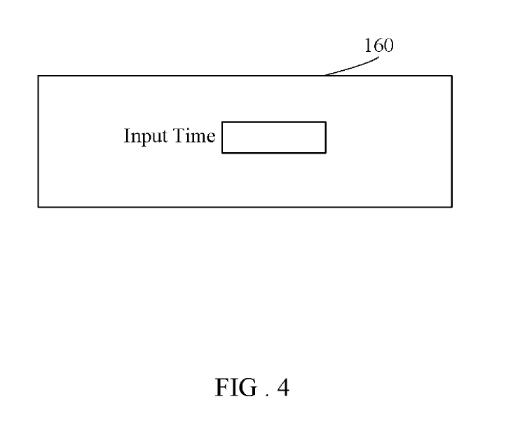

The input unit 16 is configured to generate an inquiry instruction in response to a user's operation. The user's operation is transmitted to the cloud server 20 via the first communicating unit 11. In this embodiment, the inquiry instruction contains a time period. The input unit 16 provides a graphic user interface (GUI) 230 in responds to the user's operation to enable the user to input the input time period, and generates the inquire instruction when the time period is inputted (see FIG. 4). In another embodiment, the inquiry instruction does not contain the input period.

The display unit 17 is configured to display corresponding hot spots identified by the cloud server 20 in response to the inquiry instruction.

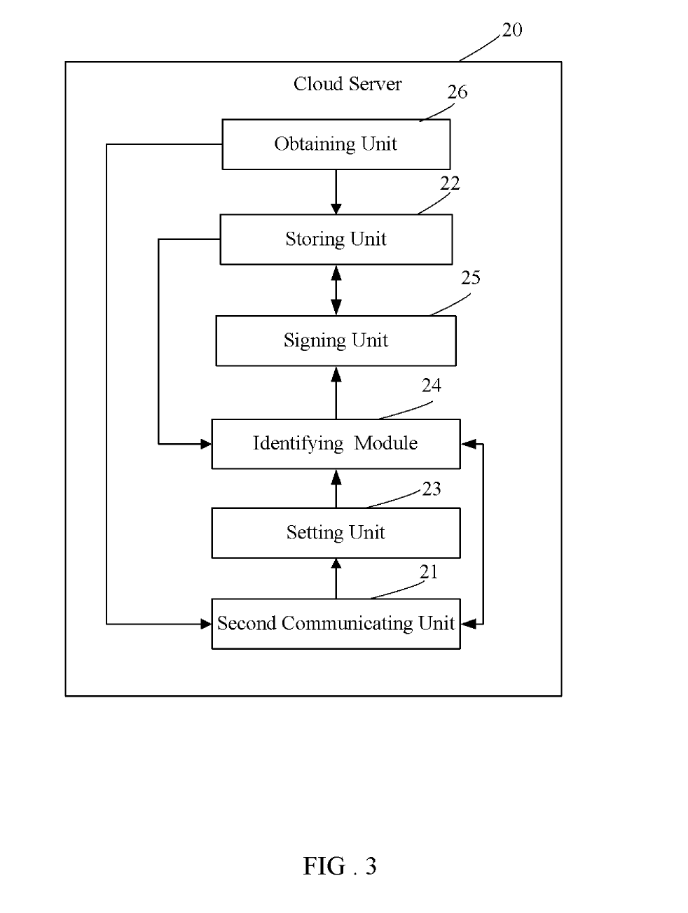

FIG. 3 shows that the cloud server 20 is configured to receive the terminal data, and identify the hot spots based on the terminal data. The cloud server 20 includes a second communicating unit 21, a storing unit 22, a setting unit 23, an identifying module 24, a signing unit 25, and an obtaining unit 26.

The second communicating unit 21 is configured to receive the terminal data and the inquiry instruction from the mobile terminal 10.

The storing unit 22 is configured to store an electronic map and the received terminal data.

The setting unit 23 is configured to set a predetermined period and a predetermined number in response to the inquiry instruction. For example, when the inquiry instruction contains the time period, the setting unit 23 sets the predetermined period according to the time period of the inquiry instruction. When the inquiry instruction does not contain the time period, the predetermined period may be set as a time period, such as an hour, before the inquiry instruction is received.

The identifying module 24 is configured to determine positions of the electronic map to be hot spots based on the number of the terminal data received from the same position in a predetermined period according to the terminal data. For example, the identifying module 24 selects the terminal data which includes the time information being within the predetermined period. The identifying module 24 is further configured to respectively count the number of identifiers of mobile terminal which send the terminal data from the same position. The identifying module 24 is further configured to determine whether the number of the identifiers is equal to the predetermined number, and to determine the corresponding positions to be hot spots when the number of the identifiers is equal to the predetermined number. For another example, the identifying module 24 is configured to select the terminal data which comes from the same position. The identifying module 24 is further configured to determine whether the information of the selected terminal data is within the predetermined period. The identifying module 24 further counts the number of the identifiers of the selected terminal data from the same position in the predetermined period. The identifying module 24 further determines whether the number of the identifiers is equal to the predetermined number, and determines the corresponding positions to be hot spots when the number of the identifiers is equal to the predetermined number.

The signing unit 25 is configured to assign marks in the positions of the electronic map which are determined to be hot spots, and store the assigned marks in the storing unit 22. In this embodiment, the assigned marks of the hot spots are in color.

The obtaining unit 26 is configured to obtain the hot spots from the storing unit 22 and send information indicating the hot spots or the electronic map marked with the hot spots to the mobile terminals 10, in response to the inquiry instruction.

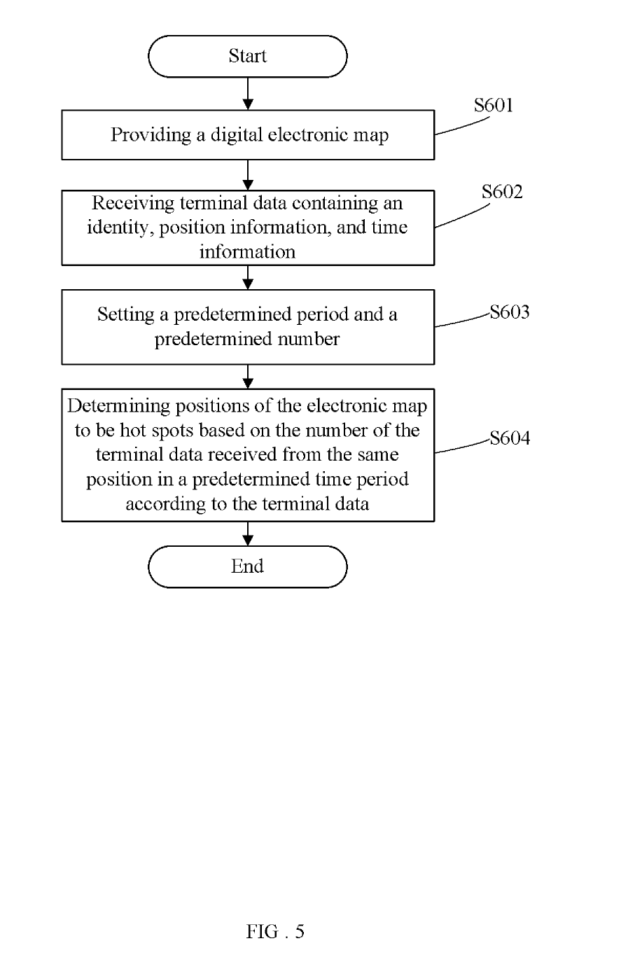

FIG. 5 shows a method for identifying hot spots executed by a cloud server. The method for identifying hot spots includes the following steps.

In step S601, providing an electronic map.

In step S602, receiving terminal data from the mobile terminals containing an exclusive identifier of corresponding mobile terminal, position information where the corresponding mobile terminal sends the terminal data, and time information when the terminal data is received.

In step S603, setting a predetermined time period and a predetermined number. The predetermined time period is set in response to an inquiry instruction which comes from the terminal data. The predetermined time period is set according to a time period which is inputted into the corresponding mobile terminal by a user and contained in the inquiry instruction. The predetermined time period is a time period before the inquiry instruction is received.

In step S604, determining positions of the electronic map to be hot spots based on the number of the terminal data received from the same position in a predetermined time period according to the terminal data

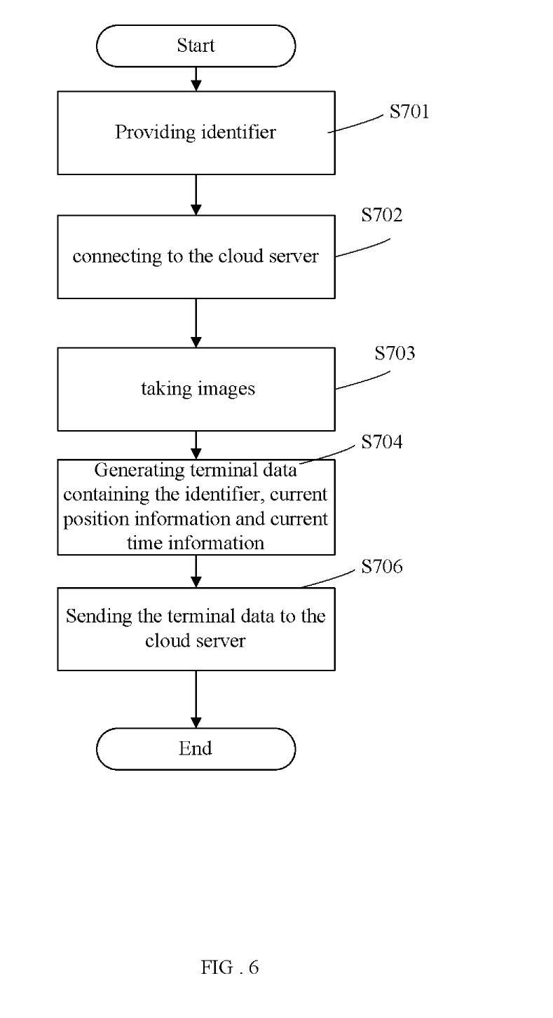

Referring to FIG. 6, the mobile terminal generates the terminal data according to the following steps:

In step S701, providing an exclusive identifier.

In step S702, connecting to the cloud server.

In step S703, taking images.

In step S704, generating terminal data containing the exclusive identifier of the corresponding mobile terminal, the position information where the images are taken, and the time information when the images are taken.

In step S706, sending the terminal data to the cloud server.

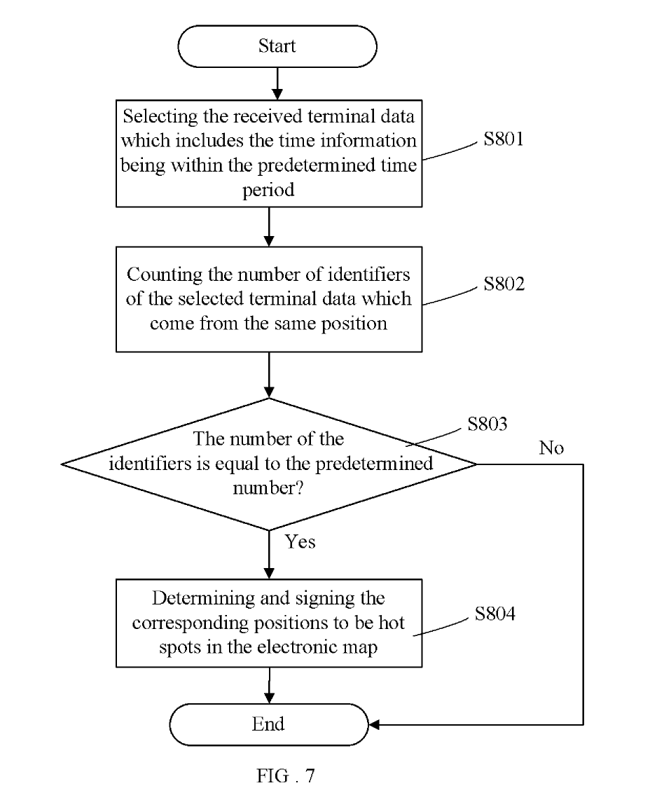

Referring to FIG. 7, details of performing step S604 of FIG. 5 in accordance with a first embodiment is shown in the steps below.

In step S801, selecting the received terminal data which includes the time information being within the predetermined time period.

In step S802, counting the number of the identifiers of terminal mobiles according to the selected terminal data which come from the same position.

In step S803, determining whether the number of the identifiers is equal to the predetermined number. The process goes to the step 804 when the number of the identifiers is equal to the predetermined number, the process ends when the number of the identifiers does not reach the predetermined number.

In step S804, determining the corresponding positions to be hot spots and assigning marks in the hot spots in the electronic map.

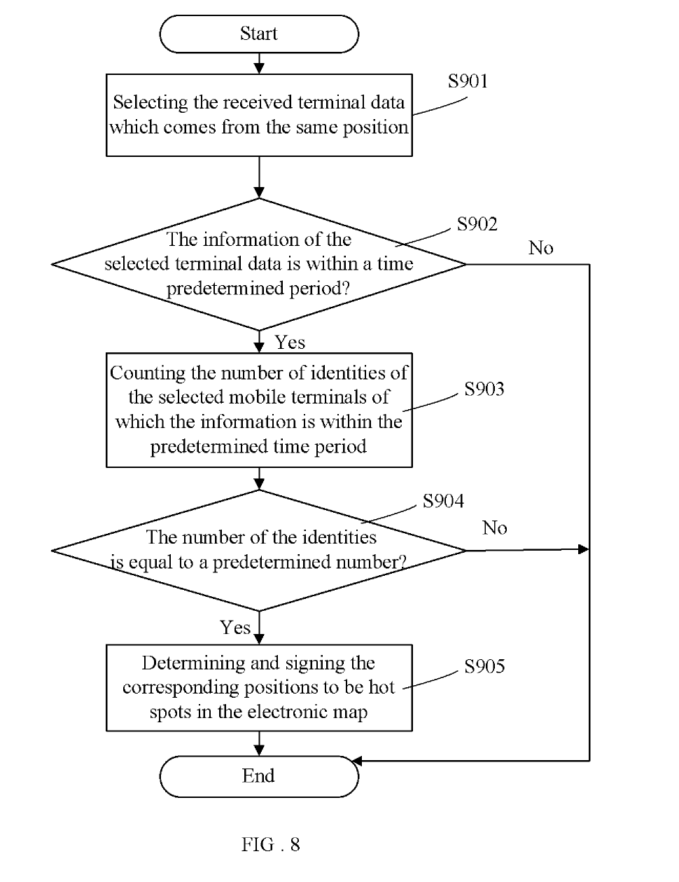

Referring to FIG. 8, details of performing step S604 of FIG. 5 in accordance with a first embodiment is shown in the steps below.

In step S901, selecting the received terminal data come from the same position.

In step S902, determined whether the information of the selected terminal data is within the predetermined time period. The process goes to step S903 when the information of the selected terminal data is within the predetermined time period; The process ends when the information of the selected terminal data is without the predetermined time period

In step S903, counting the number of identifiers of the selected mobile terminals of which the information is within the predetermined time period.

In step S904, determining whether the number of the identifiers is equal to a predetermined number. The process goes to the step 905 when the number of the identifiers is equal to the predetermined number, the process ends when the number of the identifiers does not reach the predetermined number.

In step S905, determining the corresponding positions to be hot spots and assigning marks in the hot spots in the electronic map when the number of the identifiers is equal to the predetermined number.

It is to be understood, however, that even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A mobile terminal, comprising:
an imaging unit taking images and generating a detecting signal when the images are taken;
a detecting unit detecting whether the mobile terminal connects to a cloud server in response to the detecting signal, and generating an obtaining signal when it is detected that the mobile terminal connects to the cloud server;
a GPS unit obtaining current time information and current position information of the mobile terminal in response to the obtaining signal; and
a communicating unit sending the time information and the position information to the cloud server such that the cloud server identifiers hot spots based on the number of terminal data from the same position in a predetermined time period according to the time information and the position information from the mobile terminal.

2. A cloud server, the cloud server capable of receiving terminal data from a plurality of mobile terminals, the terminal data comprising position information of the corresponding mobile terminal, time information when the cloud server receives the terminal date from the corresponding mobile terminal, the cloud sever comprising:
a communicating unit receiving the terminal data;
a storing unit storing an electronic map; and
an identifying module determining positions of the electronic map to be hot spots based on the number of the terminal data from the same position in a predetermined time period according to the terminal data.

3. The cloud server of claim 2, wherein the identifying module counts the number of the terminal data based on an exclusive identifier of the corresponding mobile terminal.

4. The cloud server of claim 2, wherein the identifying module determines whether the number of the identifier of the mobile terminals sending the terminal data from the same position equals a predetermined number, the corresponding positions are determined to be hot spots when the number of the identifier of the mobile terminal equals the predetermined number.

4. The cloud server of claim 2, wherein the identifying module determines whether the number of the identifier of the mobile terminals sending the terminal data from the same position is equal to a predetermined number in the predetermined time period, the corresponding positions are determined to be the hot spots when the number of the identifier of the mobile terminal is equal to the predetermined number in the predetermined time period.

5. The cloud server of claim 2, wherein the identifying module determines whether the number of the identifier of the mobile terminals sending the terminal data from the same position is equal to a predetermined number, and determined that the time information of the terminal data from the same position is within the predetermined time period, the corresponding positions are determined to be the hot spots when the time information of the terminal data from the same position is within the predetermined time period.

6. The cloud server of claim 1, wherein the predetermined time period is a time period before the cloud server received an inquiry instruction for identifying the hot spot.

7. The cloud server of claim 1, wherein the predetermined time period is set based on a time period which is inputted into the mobile terminal by a user.

8. The cloud server of claim 1, further comprising a setting unit to set the predetermined time period and the predetermined number in response to an inquiry instruction from the mobile terminal.

9. The cloud server of claim 2, further comprising a signing unit to assign a mark in the positions of the electronic map which is determined to be the hot spots.

10. A method for identifying hot spots, the method comprising:
providing an electronic map;
receiving terminal data from plurality of mobile terminals, the terminal data comprising position information of the corresponding mobile terminal, time information when the terminal data from the corresponding mobile terminal is received; and
determining position on the electronic map to be a hot spot based on the number of the terminal data received from the same position in a predetermined time period according to the terminal data.

11. The method for identifying hot spots of claim 10, further comprising:
assigning marks in the positions of the electronic map which are identified to be the hot spots.

12. The method for identifying hot spots of claim 10, wherein the step of determining the positions of the electronic map to be the host spot further comprises steps of:
selecting the received terminal data of which the time information being within the predetermined time period;
counting the number of identifiers of the selected mobile data which comes from the same position;
determining whether the number of the identifiers is equal to a predetermined number; and
determining the corresponding positions to be hot spots when the number of the identifiers is equal to a predetermined number.

13. The method for identifying hot spots of claim 10, wherein the step of determining the positions of the electronic map to be the host spot further comprises steps of:
selecting the received terminal data comes from the same position;
determined whether the information of the selected terminal data is within the predetermined time period;
counting the number of identifiers of the selected mobile terminals of which the information is within the predetermined time period; and
determining whether the number of the identifiers is equal to a predetermined number; and
determining the corresponding positions to be hot spots when the number of the identifiers is equal to the predetermined number.

14. The method for identifying hot spots of claim 10, wherein the predetermined time period is a time period before an inquiry instruction inputted into the mobile terminal by a user for identifying the hot spot.

15. The method for identifying hot spots of claim 10, wherein the predetermined time period is set based on a time period which is inputted into the mobile terminal by a user.
